(19) United States
(12) Patent Application Publication
(10) Pub. No.: US 2005/0180533 A1
(43) Pub. Date: Aug. 18, 2005

(54) Method and device for synchronization upon reception of a signal and echoes

(76) Inventor: Emmanuel Hamman, Palaiseau (FR)

Correspondence Address: GROSSMAN, TUCKER, PERREAULT & PFLEGER, PLLC, 55 SOUTH COMMERICAL STREET, MANCHESTER, NH, 03101, US

(21) Appl. No.: 10/515,549

(22) PCT Filed: May 22, 2003
(86) PCT No.: PCT/FR03/01555

(30) Foreign Application Priority Data
May 24, 2002 (FR) 0206389

(51) Int. Cl. H04L 1/00

(52) U.S. Cl. 375/348

(57) ABSTRACT

The invention concerns a method for synchronization upon reception of a received signal obtained by adding a plurality of transmission signals, all corresponding to the same source signal comprising data blocks called symbols of predetermined duration. The invention is characterized in that it comprises: a step which consists in determining a signal representing inferences between the symbols called intersymbol inferences; a step which consists in determining times of minimum interference level which correspond to markers of the beginning of symbols and of said symbol duration, of the reception of said received signal. The invention is in particular applicable to terrestrial digital television.

This invention relates to a process and device for synchronisation upon reception of a signal and echoes.

Such reception is frequently encountered in particular in the field of the transmission of a radio signal, such as a digital television signal.

Conventionally, the emitted signal includes separate sequences or frames and reception of the signal requires a synchronisation stage.

In the context of the transmission of digital television information, the source signal is subdivided into sets of data referred to as “symbols” of known duration.

For example, in the context of the application of the transmission by radio means of a signal modulated by orthogonal frequency division multiplexing (OFDM or COFDM), one symbol designates a set of digital data transmitted in parallel by radio means on different amplitude and frequency carriers.

Typically, such a symbol comprises 8192 different values and has duration of the order of one millisecond.

In order that reception can be synchronised and for the symbols transmitted to be extracted from the received signal a sub-block of data which is repeated at the start and end of the symbol is introduced into each symbol to permit synchronisation.

For example this sub-block comprises part of the start of the symbol which is repeated at its end.

Such a sub-block is currently referred to as a guard interval or a circular prefix.

Furthermore, at the receiver, transmission by radio means is reflected in the existence of many transmission channels through which the transmission signals, which all correspond to the same source signal, pass.

The existence of a plurality of emitters and/or reflections due to the environment gives rise to echo signals carried by different transmission channels.

Thus the receiver receives several sets of transmission signals all corresponding to the same source signal, but modified and offset from one another in time.

A first transmission signal and echo signals can thus be defined.

Some transmission signals are too attenuated to be usable and reception of such signals requires that a maximum theoretical offset between usable transmission signals in time has to be defined.

The signal received therefore corresponds to the sum of these usable transmission signals.

The presence of a plurality of signals nevertheless makes specific synchronisation processes necessary so that the starts of the symbols can be detected, regardless of overlaps between the echoes.

Existing synchronisation processes and devices are based on assumptions of slow and continuous changes in the transmission channels, so that synchronisation with the signal received is only performed periodically if desynchronisation should occur.

These assumptions cannot however apply in the case of fast and/or discontinuous changes in transmission channels.

In particular, for the application of mobile reception or where moving items are present close to reception antennae and give rise to variable reflections (people, vehicles), the use of existing processes is reflected in multiple breaks in synchronisation and therefore losses of useful signal.

The purpose of the invention is to remedy this problem by defining a synchronisation process and device which permit synchronisation when signals transmitted on variable transmission channels are present.

This invention relates to a process of synchronisation upon reception of a received signal obtained by the addition of a plurality of transmission signals all corresponding to the same source signal and offset from each other by variable time offsets, the said source signal comprising blocks of data referred to as “symbols” of predetermined duration, each symbol comprising at the start and end the same sub-block of data referred to as the “guard interval” of a predetermined duration which is greater than or equal to a maximum theoretical offset between the said transmission signals, characterised in that it comprises:
a stage of determining a signal representing interferences between the symbols of the different transmission signals, referred to as “inter-symbol interferences”;
a stage of periodically determining an instant of minimum interference level for intervals of time of duration equal to the said symbol time, these instants corresponding to references for the start of symbols; and
a stage of synchronising reception of the said received signal on the basis of the said start references for the symbols and the said symbol time.

In accordance with other characteristics:
said stage of determining the signal representing inter-symbol interference comprises:
   a substage of applying a delay equal to the said symbol time less the duration of the said guard interval to the received signal in order to deliver a delayed signal;
   a substage of calculating the values of the intercorrelation function between the said received function and the said delayed signal in order to produce an intercorrelation signal; and
   a substage of inverting this intercorrelation signal in order to deliver the said interference signal;
the said substage of calculating the values of the intercorrelation function between the received signal and the delayed signal comprises a substage of averaging the values of this function in a sliding time window of predetermined length;
said received signal comprises a plurality of known reference data known as “pilots”, and the said stage of determining a signal representative of inter-symbol interference comprises:
   a substage of transforming the said received signal from a time base to a frequency base in a time window of length equal to the said symbol time;
   a substage of extracting the said pilots;
   a substage of calculating the values of the autocorrelation function for the pilots in order to produce a pilot autocorrelation signal;
   a substage of transforming the said pilot autocorrelation signal from a frequency base to a time base to produce a signal representing the echo profile corresponding to the cumulative energy distribution of the transmission signals in the said time window; and
   a substage of calculating the values of the convolution function between the echo profile signal and a reference signal in order to directly obtain the said signal representing inter-symbol interference;
said stage of periodically determining instants of minimum interference level comprises:
   a substage of determining the instant at which the inter-symbol interference reaches a minimum level during a first time interval of length equal to the symbol time; and
   a substage of recursive determination of the instants at which the inter-symbol interference signal reaches a minimum level during time intervals of a duration equal to the symbol time which start a predetermined time after the above instant of minimum interference level;
said predetermined time corresponds to a half symbol time added to a whole number of symbol times;
said stage of synchronisation corresponds to extraction of data from the signal received during processing intervals of predetermined length of which the start instant is fixed in relation to the said symbol start references;
the process comprises, after said stage of determining instants of minimum interference level, a stage of determining the difference between the time interval separating two consecutive minimum interference level instants and the said symbol time in order to produce a measure of synchronisation variation;
following said stage of determining synchronisation variation it includes a stage of compensating for that variation;
after said synchronisation stage it comprises a stage of transforming the synchronised received signal from a time base to a frequency base;
said compensation stage corresponds to a phase rotation stage so as to perform circular permutation of a quantity of data corresponding to the said synchronisation variation within each symbol;
said source signal is a multicarrier digital television signal transmitted by radio means modulated by orthogonal frequency division multiplexing;
the process is applied in a discontinuous manner; and
the process is applied continuously and said stage of determining minimum interference level instants is performed for each time interval of a duration equal to the said symbol time.

The invention also relates to a computer program which includes program code instructions for carrying out the stages of the process as described above when the said program is executed on a computer.

The invention also relates to a program component which comprises a logical configuration dedicated to executing stages of the process as described above.

The invention also relates to a device for synchronisation upon receipt of a received signal obtained by adding a plurality of transmission signals all corresponding to the same source signal and offset from each other by variable spaces of time, the said source signal comprising blocks of data referred to as “symbols” of predetermined duration, each symbol comprising a same sub-block of data referred to as the “guard interval” at the start and end, of a predetermined length which is greater than or equal to a maximum theoretical offset between the said transmission signals, characterised in that it comprises:
a module for calculating the signal representing interference between the symbols of the different transmission signals, designated “inter-symbol interference”, and
a module for determining a symbol start reference for each time interval of length equal to the said symbol time, in relation to the instants at which the inter-symbol interference signals reach a minimum in order to produce a synchronisation system permitting synchronisation.

According to other features of the device of the invention:
it also comprises a module for transforming a time base into a frequency base, receiving the said received signal and the said synchronisation signal as an input in order to transform the said received signal during processing intervals of predetermined length, the start instant of which is determined in relation to the said symbol start references included in the said synchronisation signal;
it also comprises a module for determining a value for synchronisation variation on the basis of the difference between the length of the interval separating two consecutive symbol start references in the synchronisation signal and the said symbol time;
it includes a phase compensation module connected as an input to the said module for determining synchronisation variation and the said module transforming from a time basis to a frequency basis in order to compensate for the said synchronisation variation in the signal delivered by the said transformation module through phase rotation;
it is associated with means for parametering the duration of the guard interval and/or the symbol time;
it is suitable for use in a discontinuous manner; and
it is suitable for continuous use.

The invention also relates to a receiver unit which comprises a synchronisation device as described above.

In accordance with other features:
the reception unit is suitable for the recovery of a signal, a digital television multicarrier source transmitted by radio means, modulated by orthogonal frequency division multiplexing.

The invention will be better understood from a reading of the following description provided purely by way of example and with reference to the appended drawing, in which:

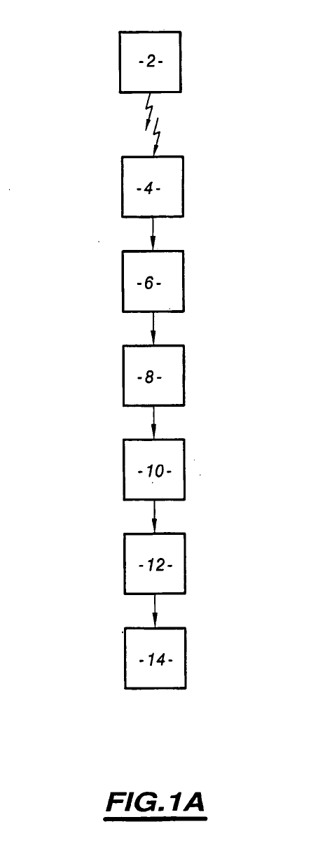

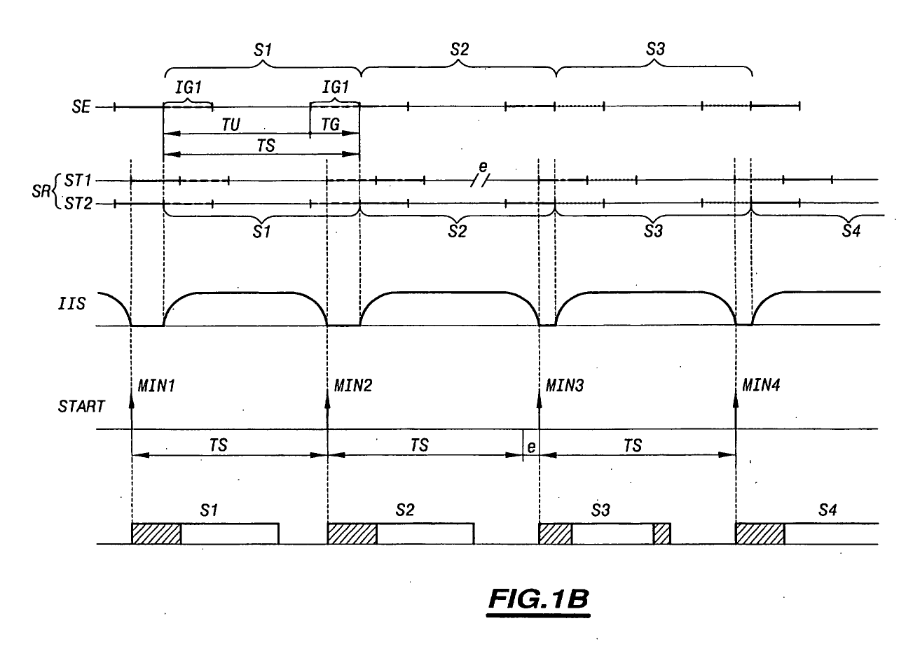

FIG. 1A is a block diagram of the process according to the invention in the case of a sudden change in a transmission channel,

FIG. 1B is a timing diagram of the signals as they appear when the stages in the process as described with reference to FIG. 1A take place,

FIG. 1A is a block diagram of a first embodiment of the process in accordance with the invention,

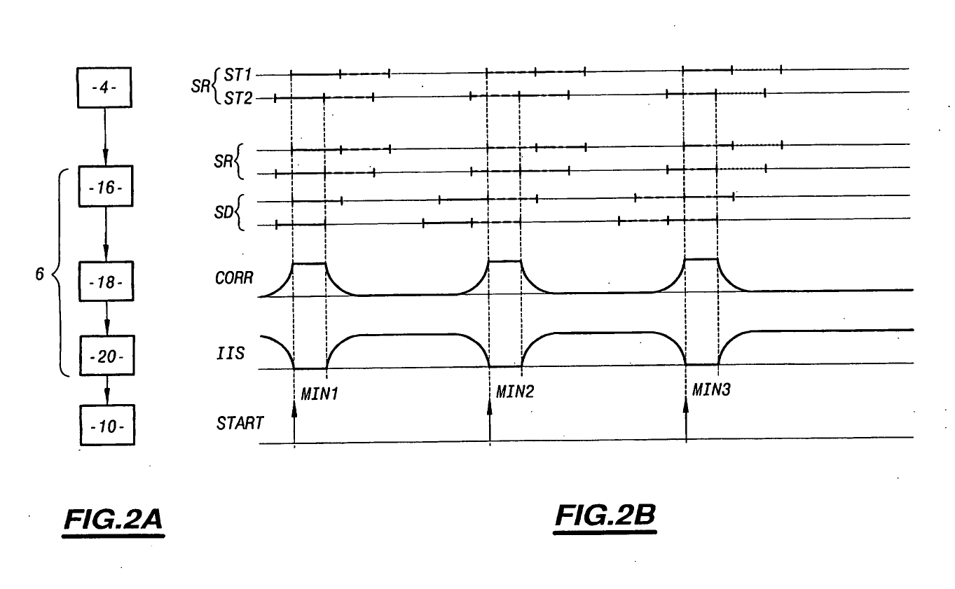

FIG. 2B is a timing diagram of the signals as they appear when the stages of the process as described with reference to FIG. 2A are in progress,

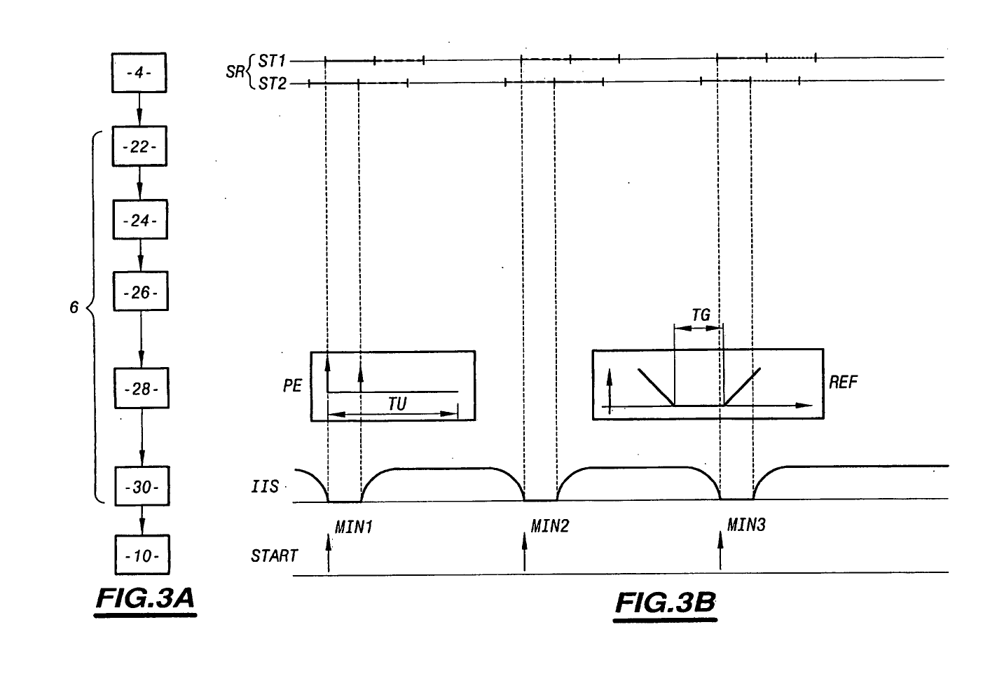

FIG. 3A is a block diagram of a second embodiment of the process in accordance with the invention,

FIG. 3B is a timing diagram of the signals as they appear in the course of the operation of the process as described with reference to FIG. 3A, and

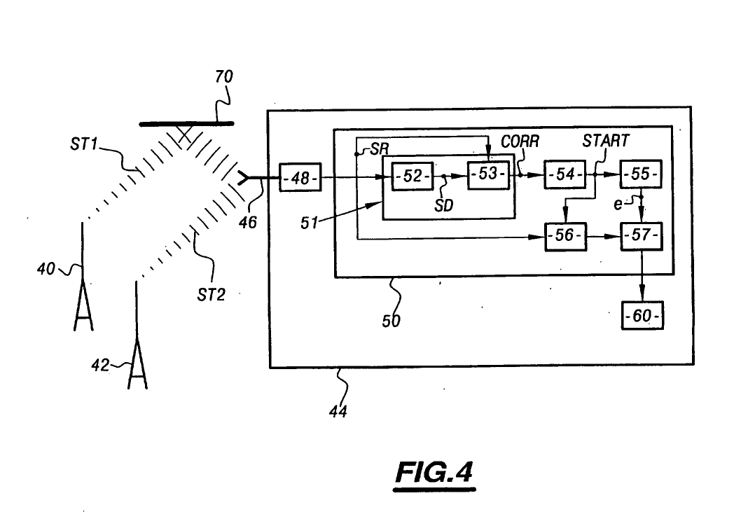

FIG. 4 is a functional diagram of a reception unit provided with a synchronisation device in accordance with the invention.

FIG. 1A shows a block diagram of the process in accordance with the invention and FIG. 1B shows a timing diagram of the principal signals as they appear during the stages of the process as described in FIG. 1A.

Thus during a transmission stage 2 a source signal SE is emitted by radio means.

This source signal comprises data blocks referred to as “symbols”, such as symbols S1 and S2.

Each symbol has a predetermined fixed symbol time TS and each symbol includes a guard interval IG corresponding to the repetition of a sub-block of data at the start of the symbol at the end of the symbol.

Thus the symbol time TS is divided into a time TU of useful data and a time TG of the guard interval.

For example, the time TG of the guard interval corresponds to ¼ to 1/32^{nd} of the time for useful data TU.

Each emitted signal symbol SE has the same symbol time TS and the same guard interval time TG, so that each symbol also has the same time TU for useful data.

During a reception stage 4 a plurality of transmission signals such as signals ST1 and ST2 are received and comprise the components of received signal SR.

All the transmission signals corresponding to the said source signal SE are transmitted via different transmission channels and are offset from each other by time differences which are different and variable.

A theoretical maximum offset is determined by an offset beyond which the attenuation is regarded as being too large to permit use of the signal.

This predetermined theoretical maximum offset is fixed in relation to the system parameters and the duration TG of the guard interval is fixed as being equal to or greater than this predetermined theoretical maximum offset.

However, in some cases transmission signals having a time offset which is greater than this predetermined theoretical maximum offset can be of such a level that their influence is not negligible.

Advantageously filtering on reception makes it possible to consider only transmission signals within a given frequency band. This filtering is achieved for example by a plurality of analogue and/or digital filters.

The signal SR received during reception stage 4 in fact corresponds to the sum of all the transmission signals ST1, ST2 after filtering.

In general, because of the different and variable time offsets, partial superimposition of the guard intervals appears between the resulting components of the different transmission signals in the received signal SR.

In the case of an offset corresponding to the maximum theoretical offset between two transmission signals ST1 and ST2 which are equal to the duration TG of the guard interval in the received signal SR, the guard interval of each symbol is repeated twice in succession.

Where this arises, it is considered that the transmission channel associated with transmission signal ST1 undergoes a sudden change giving rise to a passage time which is longer than a time e during reception.

For example this change is a consequence of movement of the reception antenna of a moving receiver and the appearance of a new reflection echo.

In a stage 6 the received signal SR is continuously processed in such a way as to produce a signal IIS which is representative of the interference between the guard intervals of the different transmission signals ST1, ST2, which are referred to as “inter-symbol interference”. This inter-symbol interference signal IIS corresponds to a representation of the relative power of the symbols adjacent to any one symbol.

For each symbol there is therefore a unique interval during which the influences of the preceding and following symbols are at minimum.

Signal IIS therefore has plateaux of minimum level close to zero corresponding to times of overlap between the guard intervals of the transmission signals as illustrated.

If the offset between transmission signals ST1 and ST2 corresponds to the length TG of the guard interval, these plateaux are reduced to peaks.

Furthermore, where this offset is greater than TG, the IIS signal also has peaks, but these do not reach the optimum value which is substantially equal to zero.

Two embodiments of stage 6 for determining the IIS signal are described in greater detail with reference to FIGS. 2A, 2B and 3A, 3B.

During a stage 10 of continuously determining times of minimum interference level a plurality of minimum interference level times are determined from the inter-symbol interference signal IIS.

This determination stage begins with a substage of determining a first instant MIN1 when the interference signal IIS reaches a minimum level in a first time interval of a length equal to the symbol time TS.

Once this first instant of minimum interference level MIN1 has been obtained, a recursive substage determining an instant at which the interference signal IIS reaches a minimum level for each new time interval of duration equal to the symbol time TS and beginning at an instant located half a symbol time TS after the preceding minimum interference level instant is initiated.

Thus

$$MINi = MIN ( I IS ) , [ ( MINi - 1 ) + \frac{TS}{2} ; ( MINi - 1 ) + \frac{3 TS}{2} ]$$

The minimum interference level times obtained in this way provide a START signal and make it possible to define symbol start references.

It therefore appears that times MIN2 and MIN3 correspond to times of minimum interference level independently of the presence of the offset e.

The process then comprises a stage of continuous synchronisation during reception starting from these symbol start references and the symbol time TS.

This synchronisation stage corresponds for example to the extraction of data included in the received signal SR during processing intervals of predetermined length, the start time of which is fixed in relation to the symbol start references.

For example, these processing intervals are of a length equal to the symbol time TS and start at the symbol start references.

As a variant, the processing intervals are of a length equal to the useful data time TU and start at times which are offset in relation to the symbol start references by an amount equal to the duration of the guard interval TG.

Thus the process in accordance with the invention makes it possible to perform synchronisation upon reception in the presence of signals transmitted on variable transmission channels and in particular makes it possible to overcome a sudden change of channel.

Furthermore, in the case described, because of the sudden change in the transmission channel for transmission signal ST1 the maximum correlation times MIN2 and MIN3 are separated by a time equal to the symbol time TS to which is added the time e produced by the change in the transmission channel.

Because of this, the remainder of the processing may be adversely affected.

In particular, in the case of the transmission of an OFDM-modulated signal by radio means an estimate of the overall transfer function for the transmission channel is calculated on the basis of the symbols extracted from the received signal SR.

The presence of such an offset e between the two symbols results in a false estimate of the overall transfer function and as a consequence an erroneous correction.

In order to overcome such errors, after stage 10 in which the times of minimum interference level are determined, the process includes a stage 12 for continuously calculating the offset between two minimum interference level times in order to provide a measure of the variation in synchronisation equal to the offset e and also denoted e.

This measurement e0 therefore corresponds to a measurement of the offset between the time interval separating two consecutive maximum correlation times and the symbol time TS, in such a way that: e=abs [MINi−MIN(i−1)−TS]. This value e is then used in a continuous correction stage 14.

For example, in the context of the transmission of a modulated signal on a plurality of carriers or a multi-carrier signal, such a correction is obtained by phase rotation to displace part of the data within the symbol in order to reconstitute all the useful data in each symbol in the proper order.

In the example described, the process in accordance with the invention is in operation continuously, and this corresponds to operation for each symbol time. However, as a variant, it is also possible to operate it in a discontinuous manner.

In this case it may be repeated at predetermined time intervals so that the variations in the transmission channels during these time intervals can be regarded as being slow and continuous.

Stage 10 for determining minimum interference level times is then carried out in a discontinuous manner. In particular the substages of recursive determination of the times when the inter-symbol interference signal IIS reaches minimum levels is carried out periodically during time intervals of a length equal to the symbol time TS and beginning at a predetermined time after the time of the preceding minimum interference level.

For example, this predetermined time corresponds to a half symbol time TS added to a whole number of symbol times TS.

If this whole number is zero, this is tantamount to performing synchronisation continuously for each symbol, otherwise the number of symbol times will correspond to the synchronisation period.

FIG. 2A shows the details of some process stages according to a first embodiment of the invention and FIG. 2B shows a timing diagram of the main signals as they appear during the stages in connection with which they are located.

As described previously, the process comprises stage 4 of receiving transmission signals ST1 and ST2, which are added together to form the received signal SR.

In a first embodiment, stage 6 of determining the signal IIS representing inter-symbol interference comprises a plurality of substages and begins with a substage 16 in the course of which the received signal SR is continuously delayed by a time corresponding to the useful data time TU, or the symbol time TS less the time TG for the guard interval.

The signal provided as an output from this substage 16 of continuously applying a delay is called SD.

During a calculation substage 18, the values of the intercorrelation function between the received signal SR and the retarded signal SD are continuously calculated so as to produce the intercorrelation signal CORR.

As the delay between the SD signal and the received signal SR is the useful data time TU, it appears that each symbol in the received signal SR and the delayed signal SD is superimposed upon itself during the guard interval time TG.

There then appears a time interval between the SR and SD signals during which they are identical and therefore during which the value of the intercorrelation signal CORR reaches a maximum level which is substantially equal to 1.

The intercorrelation signal CORR therefore has plateaux of maximum level during periods corresponding to inter-symbol interference.

Where the received signal SR corresponds to addition of the two transmission signals offset by the maximum offset corresponding to the guard interval time TG, the correlation maxima reached during inter-symbol interference therefore correspond to point maxima.

Likewise, in the case where the offset between transmission signals is greater than the time TG, the correlation maxima obtained are also point maxima but reach a value which is less than the optimum value which is substantially equal to 1.

Advantageously, the intercorrelation signal CORR is calculated by continuous calculation of the values for the intercorrelation function between the delayed signal SD and the received signal SR, and by averaging these values in a sliding window of predetermined duration such as for example a duration equal to twice the guard interval time TG.

Stage 6 finally comprises a substage 20 for inversion of the intercorrelation signal CORR in order to produce the signal IIS representing inter-symbol interference from which stage 10 of determining the times of minimum interference level is carried out as described previously.

FIG. 3A shows particular stages in the process according to a second embodiment and FIG. 3B shows a timing diagram of the main signals as they appear in the course of the stages in relation to which they are situated.

In this embodiment the source signal SE comprises a plurality of known reference information.

Conventionally, in the context of the application of the transmission of an orthogonal frequency division multiplexed signal by radio means each symbol S comprises a plurality of carriers some of which are known reference carriers referred to as “pilots”.

Typically, one carrier out of twelve is a pilot carrier.

Stage 4 of reception of received signal SR corresponding to the addition of transmission signals ST1 and ST2 will be seen in FIGS. 3A and 3B.

In this second embodiment, stage 6 for determining signal IIS representing inter-symbol interference starts with a substage 22 of transforming the received signal SR from a time base to a frequency base in a sliding time window of duration equal to the useful time TU, that is the symbol time TS less the guard interval time TG.

Typically this transformation is performed using a Fast Fourier Transform (FFT) operation.

Stage 6 then comprises a substage 24 of extracting the pilots from the frequency representation of the received signal SR, which is carried out in a conventional way.

Subsequently stage 6 comprises a substage 26 for calculation of values for the autocorrelation function for the extracted pilots in order to determine a pilot autocorrelation signal.

Subsequently this pilot autocorrelation signal is used in a substage 28 for transformation from a frequency base to a time base in order to determine a signal PE which is representative of the echo profile and corresponds to the distribution of the cumulated energy of the transmission signals ST1, ST2 within the transformation time window.

The signal PE determined during substage 28 is then used in a substage 30 for calculating the values of the convolution function between the echo profile signal and a reference signal REF in order to directly obtain the signal IIS representing inter-symbol interference.

In the example described, the reference signal REF is a signal of a general trapezoidal shape, a theoretical representation of the level of inter-symbol interference.

The REF signal has a zero plateau of a duration equal to the guard interval time TG, a gradient of −1 before this plateau and a gradient of +1 after this plateau.

Of course processes other than those described may be used to determine the IIS signal representing inter-symbol interference.

It appears therefore that the process in accordance with the invention makes it possible to synchronise reception of the signal received via variable transmission channels and also makes it possible to correct a sudden change in a transmission channel.

The process in accordance with the invention may be implemented through a dedicated program stored for example in a non-volatile memory such as a computer memory or a transferable medium memory such as a smart card.

This process may also be used to assist programmable components such as for example FPGA components whose connections are specially modified in such a way as to define a logical configuration dedicated to its execution.

FIG. 4 shows a synchronisation device implementing the process in accordance with the invention as described with reference to FIGS. 2A and 2B in the context of the reception of a digital television signal transmitted by orthogonal frequency division multiplexing, OFDM or COFDM modulation.

This figure shows two radio emitters 40, 42 emitting the same source signal SE to a receiver unit 44.

This receiver unit 44 comprises an antenna 46, a preprocessing module 48 and a synchronisation device according to the invention 50.

In general, device 50 comprises a module 51 for determining the IIS signal representing inter-symbol interference.

In the example described, this synchronisation device 50 is designed to use the first embodiment of the process according to the invention and for this comprises a delay application module 52 connected at the input to the output of preprocessing module 48 and at the output to a correlation calculation module 53.

The input of correlation calculation module 53 is likewise connected to the output from preprocessing module 48 and its output is connected to a module 54 determining the symbol start references.

The output of module 54 is connected to a module 55 determining a synchronisation variation value.

Device 50 also comprises a module 56 transforming a time base to a frequency base, the input of which is connected to the output of preprocessing module 48, and to the output of module 54 determining symbol start references.

The output from this transformation module 56 is connected to a phase compensation module 57, the input of which is connected to module 55 determining synchronisation variation.

The output from module 57 is connected to a processing module 60 which stands for all the conventional processing which has to be carried out on the received signal.

Thus, in operation, radio emitters 40 and 42 emit the same source signal SE transmitted towards antenna 46 by different transmission channels which depend in particular on the environment which is indicated symbolically by reference number 70 and which are reflected by the reception of signals ST1 and ST2 by antenna 46 of receiver unit 44.

These signals are then fed into preprocessing module 48, which places them in appropriate form by carrying out a plurality of processing operations such as an analogue/digital conversion, a baseband transposition, filtering and amplification in order to produce the received signal SR.

This is then fed to delay module 52 in order to produce delayed signal SD of a duration equal to the useful data time TU.

Module 53 then receives the received signal SR and the delayed signal SD, calculates the values for the intercorrelation function between these signals and produces the intercorrelation signal CORR as an output.

Module 54 receives the CORR signal and for each time interval of a length equal to the symbol time TS determines the time at which the intercorrelation signal CORR reaches its maximum level.

These times of maximum correlation level make it possible to determine the symbol start references MIN which are produced in the form of a synchronisation signal START.

Module 56 then performs transformation of the received signal SR from a time base to a frequency base such as a Fourier transform or a Fast Fourier transform (FFT) in time windows of a duration equal to the useful data time TU and starting at each symbol start reference MIN transmitted by the START signal.

Simultaneously, using the START signal, module 55 determining variation in synchronisation determines a measure of the variation in synchronisation between the two symbol start references and produces a signal e representing the latter.

Module 57 then receives signal e and the signal provided by module 56 as an input and through phase rotation compensates for the variation in synchronisation and produces the symbols present in the received signal.

Then, in the context of the reception of a digital television signal, these symbols are used in module 60 to perform a calculation to estimate the overall transfer function for the transmission channel, and then compensation for the variations brought about through transmission and finally decoding and restoration of the information transmitted.

In the example described synchronisation device 50 operates continuously but it may also operate discontinuously.

In this case, optimum functioning requires that periods during which variations in the transmission channels can be regarded as being slow and continuous be defined.

Advantageously, receiver unit 44 comprises, in association with synchronisation device 50, a parametering module for the latter in order to enable a user to parameter in particular the symbol time TS and the guard interval time TG.

A device which is similar to the device described can be used to implement the second embodiment of the process of the invention described.

However, in this case a feedback loop is introduced between module 56 performing the Fourier transform and module 50 determining the IIS signal.

Furthermore, in this case module 50 includes elements other than those described which can be defined through a knowledge of the process as described with reference to FIGS. 3A and 3B.

It appears therefore that a device in accordance with the invention makes it possible to synchronise upon reception a signal transmitted by variable transmission channels.

In particular, a device of this kind is particularly suitable for a moving receiver unit.

For example, this receiver unit is incorporated into a moving land based digital television receiver combination, or again digital radio signals or vehicles carried by multicarrier signals.

1. A process for the synchronization upon reception of a received signal obtained by the addition of a plurality of transmission signals all corresponding to the same source signal and offset from each other by variable time offsets, the source signal comprising blocks of data referred to as “symbols” of predetermined duration, each symbol comprising at the start and end a same sub-block of data referred to as a “guard interval” of predetermined duration which is greater than or equal to a maximum theoretical offset between the transmission signals, the process comprising:
a stage of determining a signal representing interference between the symbols of the different transmission signals referred to as “inter-symbol interference”;
a stage in which a time of minimum interferences level is determined periodically for time intervals of a length equal to the sad symbol time, these times corresponding to symbol start references; and
a stage of synchronizing reception of the received signal (SR) from the symbol start references corresponding to the times of minimum interference level and the symbol time.

2. A process according to claim 1, wherein stage of determining a signal representing inter-symbol interference comprises:
a substage applying a delay equal to the symbol time less the guard interval time to the received signal in order to produce a delayed signal;
a substage of calculating values of the intercorrelation function between the received signal and the delayed signal comprising a substage of averaging the values of this function over a sliding time window of predetermined length so as to use an intercorrelation signal; and
a substage of inversion of this intercorrelation signal in order to produce the interference signal.

3. A process according to claim 1, wherein the received signal comprises a plurality of known reference information referred to as “pilots” and stage of determining a signal representing inter-symbol interference comprises:
a substage of transformation of the received signal from a time base to a frequency base over a time window of a duration equal to the symbol time less the guard interval time;
a substage for extraction of the pilots;
a substage for calculating values of the autocorrelation function for the pilots in order to produce a pilot autocorrelation signal;
a substage of transformation of the pilot autocorrelation signal from a frequency base to a time base in order to produce a signal representing the echo profile and corresponding to the distribution of the cumulative energy of the transmission signals within the time window; and
a substage for calculating the values of the convolution function between the echo profile signal and a reference signal in order to obtain the signal representing inter-symbol interference directly.

4. A process according to claim 1, wherein the stage of periodically determining minimum interference level times comprises:
a substage determining the time when the inter-symbol interference signal reaches a minimum level in a first time interval of length equal to the symbol time; and
a substage of recursive determination of the times at which the inter-symbol interference signal reaches a minimum level during time intervals of length equal to the symbol time which start a predetermined time after the time of the preceding minimum interference level.

5. A process according to claim 4, wherein the predetermined time corresponds to a half symbol time added to a whole number of symbol times.

6. A process according to claim 1, wherein synchronization stage corresponds to extraction of the data from the received signal during processing times of predetermined lengths, the starting time of which is fixed in relation to the symbol start references.

7. A process according to claim 1, wherein after the stage of determining minimum interference level times, the process comprises:
a stage for determining the offset between the interval time separating two consecutive minimum interference level times and the symbol time in order to produce a measurement of the variation in synchronization.

8. A process according to claim 7, wherein after the stage of determining a variation in synchronization, the process comprises a stage of compensating for this variation.

9. A process according to claim 8, wherein after the synchronization stage, the process comprises a stage of transformation of the received signal from a time base to a frequency base.

10. A process according to claim 9, wherein the compensation stage corresponds to a phase rotation stage so as to perform a circular permutation within each symbol of a quantity of data corresponding to the synchronization variation.

11. A process according to claim 1, wherein the source signal is a digital television multicarrier signal transmitted by radio means and modulated by orthogonal frequency division multiplexing.

12. A process according to claim 1, wherein the process is operated in a discontinuous way.

13. A process according to claim 1, wherein the process is operated continuously and that the stage of determining minimum interference level times is carried out for each time interval of a length equal to the symbol time.

14. A computer program product for the synchronization upon reception of a received signal obtained by the addition of a plurality of transmission signals all corresponding to the same source signal and offset from each other by variable time offsets, the source signal comprising blocks of data referred to as “symbols” of predetermined duration, each symbol comprising at the start and end a same sub-block of data referred to as a “guard interval” of predetermined duration which is greater than or equal to a maximum theoretical offset between the transmission signals the computer program product residing on a computer readable medium having a plurality of instructions stored thereon which, when executed by the processor, cause that processor to:
determine a signal representing interference between the symbols of the different transmission signals referred to as “inter-symbol interference”;
determine a time of minimum interferences level periodically for time intervals of a length equal to the symbol time, these times corresponding to symbol start references: and
synchronize reception of the received signal from the symbol start references corresponding to the times of minimum interference level and the symbol time.

15. A programmed component for the synchronization upon reception of a received signal obtained by the addition of a plurality of transmission signals all corresponding to the same source signal and offset from each other by variable time offsets, the source signal comprising blocks of data referred to as “symbols” of predetermined duration, each symbol comprising at the start and end a same sub-block of data referred to as a “guard interval” of predetermined duration which is greater than or equal to a maximum theoretical offset between the transmission signals, the programmed component, characterised in that it comprises including a logical configuration configured to:
determine a signal representing interference between the symbols of the different transmission signals referred to as “inter-symbol interference”;
determine a time of minimum interferences level periodically for time intervals of a length equal to the symbol time, these times corresponding to symbol start references; and
synchronize reception of the received signal from the symbol start references corresponding to the times of minimum interference level and the symbol time.

16. A device for synchronization upon reception of a received signal obtained by the addition of a plurality of transmission signals all corresponding to the same source signal and offset from each other by variable time offsets, the source signal comprising data blocks referred to as “symbols” of predetermined duration, each symbol comprising at the beginning and at the end a same sub-block of data referred to as a “guard interval” of predetermined duration which is greater than or equal to a maximum theoretical offset between the transmission signals, the device comprising:
a module for calculating a signal representing interference between the symbols in the different transmission signals referred to as “inter-symbol interference”; and
a module for determining a symbol start reference periodically for time intervals of a length equal to the symbol time in relation to the times at which the inter-symbol interference signal reaches a minimum level and corresponding to the minimum interference level times in order to produce a synchronization signal which makes synchronization possible.

17. A device according to claim 16, further comprising a module for transformation from a time base to a frequency base receiving as an input the received signal and the synchronization signal in order to transform the said received signal during processing intervals of a predetermined length the start time of which is determined in relation to the symbol start references included in the synchronization signal).

18. A device according to claim 17, further comprising a module for determining a synchronization variation value from the offset between the time interval separating one of: two consecutive symbol start references: and the synchronization signal and the symbol time.

19. A device according to claim 18, further comprising a phase compensation module connected as an input to the module for determining synchronization variation and to the module transforming a time basis to a frequency basis in order to compensate for the synchronization variation in the signal delivered by the transformation module through phase rotation.

20. A device according to claim, further comprising means for parametering one of the guard interval time and the symbol time.

21. A device according to claim 16, wherein the device is configured to be operated discontinuously.

22. A device according to claim 16, wherein the device is configured to be operated continuously.

23. A unit for the reception of a radio signal, the unit being configured for the reception of a digital television multicarrier source signal transmitted by radio means, modulated by orthogonal frequency division multiplexing, the unit being configured for synchronization upon reception of a received signal obtained by the addition of a plurality of transmission signals all corresponding to the same source signal and offset from each other by variable time offsets, the source signal comprising data blocks referred to as “symbols” of predetermined duration, each symbol comprising at the beginning and at the end a same sub-block of data referred to as a “guard interval” of predetermined duration which is greater than or equal to a maximum theoretical offset between the transmission signals, the unit comprising a synchronization device including:
a module for calculating a signal representing interference between the symbols in the different transmission signals referred to as “inter-symbol interference”, and
a module for determining a symbol start reference periodically for time intervals of a length equal to the symbol time in relation to the times at which the inter-symbol interference signal reaches a minimum level and corresponding to the minimum interference level times in order to produce a synchronization signal which makes synchronization possible.
